(19) United States
(12) Patent Application Publication
(10) Pub. No.: US 2006/0224558 A1
(43) Pub. Date: Oct. 5, 2006

(54) Associating multiple categories with single payee or payor in financial software application

(76) Inventors: John Reed Flora, Pleasanton, CA (US); Matthew James Homier, San Francisco, CA (US); Andrew Kwan Chan, Cupertino, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/388,414

(22) Filed: Mar. 24, 2006

Related U.S. Application Data
(60) Provisional application No. 60/665,430, filed on Mar. 24, 2005.

(51) Int. Cl. G06F 17/30; G06F 7/00

(52) U.S. Cl. 707/1

(57) ABSTRACT

When a user is entering a transaction for a payee or payor, categories that are associated with the payee/payor are given prominence within a drop-down menu or other selection mechanism. Categories can be associated with payees/payors based on recency and/or frequency of use in connection with such payees/payors, as well as on other factors. Associated categories can be shown atop the drop-down menu, and/or can be otherwise visually distinguished over other categories. This provides easy access and consistency in categorization for the payee, and gives users the ability to consistently and easily apply categories appropriate to a payee/payor.

### CROSS-REFERENCE TO RELATED PATENT APPLICATIONS

The present invention claims priority from U.S. Provisional Patent Application Ser. No. 60/665,430 (Attorney Docket Number 9402), for CATEGORIZATION MANAGEMENT, filed Mar. 24, 2005, the disclosure of which is incorporated herein by reference.

The present invention is related to U.S. Utility patent application Ser. No. ______ (Attorney Docket Number 9911), for INTELLIGENT AUTO-FILL OF TRANSACTION DATA, filed on the same date as the present application, the disclosure of which is incorporated herein by reference.

### BACKGROUND

The present invention relates to entry of transaction data in a personal financial software package.

Conventional financial software applications have categorization functionality that allows users to specify a category for a transaction. In some cases, a transaction can be split among two or more categories.

To assist in entry of categorization information, some financial software applications memorize the most recently used category for a payee/payor. This memorization can take place in response to an explicit user command, or in response to observed behavior. For example, if the user enters a category of “Gas” for a transaction where the payee is “Shell”, the software application memorizes this usage of the “Gas” category in its records.

Once such memorization has taken place, the category field can be automatically populated whenever the user enters a new transaction for the same payee/payor. Thus, continuing the above example, future transactions for “Shell” could be automatically populated with a category of “Gas”. Of course, the user is free to override the category and supply a different category if desired. If the user overrides the populated category with a different category, the application memorizes the new usage of the category, and no longer memorizes the previous usage.

Accordingly, in conventional financial software applications, there is no mechanism available for the user to easily associate more than one category with a particular payee/payor.

Conventionally, users can select a category for a transaction by navigating within a drop-down menu or other user interface element from selecting from a list of categories. Typically, many categories are available; other than the single most recently applied category, no distinction is made between categories that have previously been applied to or associated with the user-entered payee/payor, and other categories. The length of the list makes it difficult for users to locate and select a desired category for a transaction.

### SUMMARY

In various embodiments, the present invention provides methods and systems for displaying candidate categories for a financial transaction in such a way as to give prominence to two or more categories that have previously been associated with the payee/payor for the transaction being entered.

When a user is entering a transaction for a payee or payor, a number of categories that are associated with the payee/payor are shown atop the normal category dropdown list. This provides easy access and consistency in categorization for the payee/payor, and gives users the ability to consistently and easily apply categories appropriate to a payee/payor. The maximum number of such associated categories can be set to any desired number, and is not limited to one.

The present invention reduces the need for users to navigate a long category list in order to find a category that is applicable to the transaction being entered. A plurality of categories that are commonly (or recently) used in connection with the user-entered payee/payor are given prominence within a drop-down menu, so that the user can more easily select those categories for the current transaction. User entry of a transaction having a new category for a payee/payor causes a new association to be stored, so that future transactions for the same payee/payor can be more easily categorized using the stored associations between payees/payors and categories.

The present invention allows multiple categories to be associated with a single payee/payor. Payees/payors that are sometimes associated with, for example, a Groceries category and other times are associated with Household category can have two (or more) stored associations. When the user enters a new transaction for the payee/payor, he or she can easily select among the two (or more) categories associated with that payee/payor, without having to navigate through a long list containing all categories. As will be described in more detail below, in one aspect the present invention displays associated categories more prominently than other categories within a pull-down menu or other selection mechanism. For example, categories associated with the payee/payor can be listed first, followed by other categories; the user can select among any of the listed categories.

The user can, if he or she wishes, select any of the associated categories, or can select any of the other categories, as desired. Associations between payee/payor and category are created and/or updated according to the user's entries and selections of categories.

In one embodiment, the last five categories used for the payee/payor are shown, followed by a list of other categories. The most recently used category for the payee/payor is shown first in the list, with other associated categories being shown in order of recency of use.

### BRIEF DESCRIPTION OF THE DRAWINGS

The accompanying drawings illustrate several embodiments of the invention and, together with the description, serve to explain the principles of the invention.

FIG. 1 is a screen shot depicting an example of a pull-down menu including a plurality of categories associated with a payee/payor, along with other categories, according to one embodiment of the present invention.

FIGS. 2A and 2B are screen shots depicting an example of transaction entry where multiple categories are associated with a payee/payor, along with other categories, according to one embodiment of the present invention.

FIG. 3 is a block diagram depicting a functional architecture for implementing the present invention according to one embodiment.

FIG. 4 is a flow diagram depicting a method for practicing the present invention according to one embodiment.

One skilled in the art will recognize that these Figures are examples of the operation of the invention according to one embodiment, and that other user interface arrangements and modes of operation can be used without departing from the essential characteristics of the invention. In particular, the screen shots and user interface elements shown in the Figures are exemplary; other layouts, arrangements, formats, and user interface features may be provided without departing from the essential characteristics of the present invention.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

For illustrative purposes, the invention is described in connection with entry of category information for transactions in a personal financial software package or accounting package. Various specific details are set forth herein and in the Figures, to aid in understanding the present invention. However, such specific details are intended to be illustrative, and are not intended to restrict in any way the scope of the present invention as claimed herein. In particular, one skilled in the art will recognize that the invention can be used in connection with category names, payee/payor names, or any other elements of financial transactions. References herein to “categories” should thus be taken as exemplary, and are not intended to limit the invention to that particular transaction component. In addition, the particular screen layouts, appearance, and terminology as depicted and described herein, are intended to be illustrative and exemplary, and in no way limit the scope of the invention as claimed.

Output generated by the invention can be displayed on a screen, transmitted to a remote device, stored in a database or other storage mechanism, or used in any other way. In addition, in some embodiments, the invention makes use of input provided to the computer system via input devices such as a keyboard, mouse, touchpad, or the like. Such hardware components, including their operation and interactions with one another and with a central processing unit of the computer, are well known in the art of computer systems and therefore are not depicted here.

System Architecture

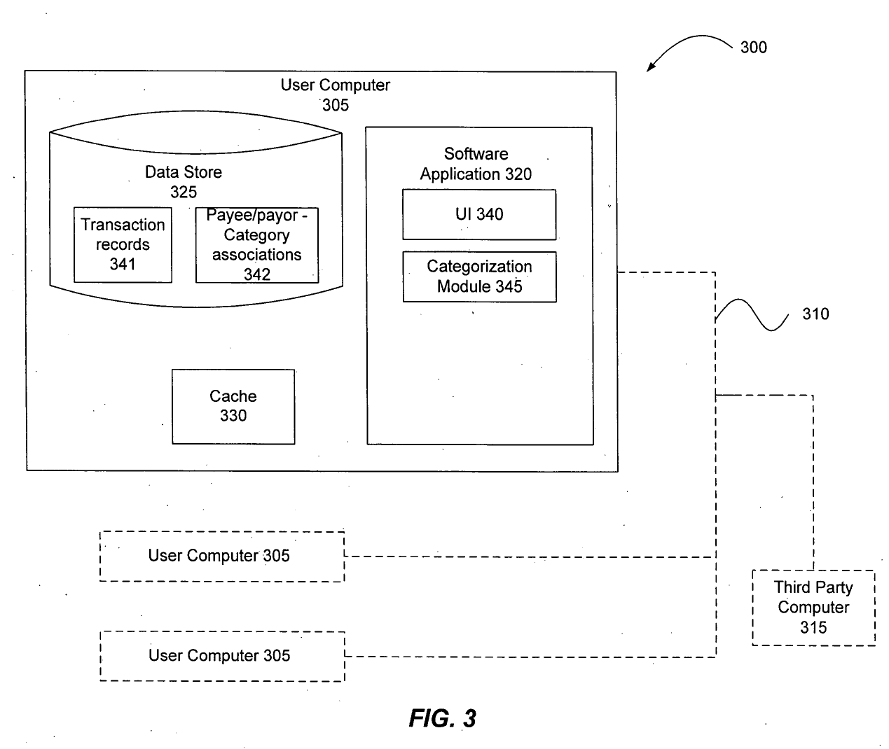

FIG. 3 is a block diagram illustrating the architecture of one embodiment of a system 300 useful for supporting a software application 320 for implementing intelligent auto-fill techniques as described herein. In such a system 300, there is provided at least one user computer 305, which may be a stand-alone device or may be communicatively coupled to a network 310 and/or one or more third party computers 315, as indicated by dotted lines.

The user computer 305 is of conventional design, and includes a processor, an addressable memory, and other conventional features (not illustrated) such as a display, local memory, input/output ports, and a network interface. In other embodiments one or more of the components of the user computer 305 may be located remotely and accessed via a network, e.g., 310. The network interface and a network communication protocol provide access to a network 310 and other computers, such as other user computers 305 or third party computers 315, along with access to the Internet, via a TCP/IP type connection, or to other network embodiments, such as a LAN, a WAN, a MAN, a wired or wireless network, a private network, a virtual private network, or other networks. In various embodiments the user computer 305 may be implemented on a computer running a Microsoft operating system, Mac OS, various flavors of Linux, UNIX, Palm OS, and/or other operating systems.

The third party computers 315, if present, also may be computer systems, similar to the user computer described above. For example, one embodiment of a third party computer 315 is a financial institution computer system, which provides transactions processing and clearing functionality for user software. The financial institution could be a securities brokerage company, a bank or credit union, a credit card company, or financial institutions. In this embodiment, the user software application 320 described herein may be a financial management software package capable of communicating with the financial institution computer system to access information from pre-existing user accounts (e.g., obtain account balances to determine available funds), and provide payment instructions for making payments to vendors.

The user computer 305 includes a software application 320, data store 325, and data cache 330. The software application 320 includes a number of executable code portions and data files. These include code for creating and supporting a user interface 340 according to one embodiment of the present invention, as well as for implementing categorization functionality. In other embodiments, the software application 320 can also be implemented as a standalone application outside of a financial management software package.

The software application 320 is responsible for orchestrating the processes performed according to the methods of the present invention. The software application 320 includes a categorization module 345 according to one embodiment of the present invention.

The categorization module 345 enables the system 300 to perform the functions described above. The categorization module 345 is one means for generating and displaying drop-down menus for categories and/or other data items, as described above.

The above-described software portions need not be discrete software modules. The software configuration shown is meant only by way of example; other configurations are contemplated by and within the scope of the present invention.

The software application 320 may be provided to the user computer 305 on computer readable media, such as a CD-ROM, diskette, or by electronic communication over the network 310 from one of the third party computers 315 or other distributors of software, for installation and execution thereon. Alternatively, the software application 320, data store 325, and data cache 330 can be hosted on a server computer, and accessed over the network 310 by the user, using for example a browser interface to the software application 320.

The data store 325 may be a relational database or any other type of database that stores the data used by the software application 320, for example account information in the financial management application embodiment referenced above. The data store 325 may be accessible by the software application 320 through the user interface 340. Some data from the data store 325 may be added to the data cache 330 upon initialization of the software application 320. The software application 320 and the data store 325 may be stored and operated on a single computer or on separate computer systems communicating with each other through a network 310. In one embodiment, the data store 325 includes transaction records 341 and also includes associations 342 between payees/payors and categories, as described in more detail below.

The data cache 330 is a standard cache of small, fast memory holding recently accessed data. The data cache 330 may include, for example, one or more lists of elements according to one embodiment of the present invention.

One skilled in the art will recognize that the system architecture illustrated in FIG. 3 is exemplary, and that the invention may be practiced and implemented using many other architectures and environments.

Method

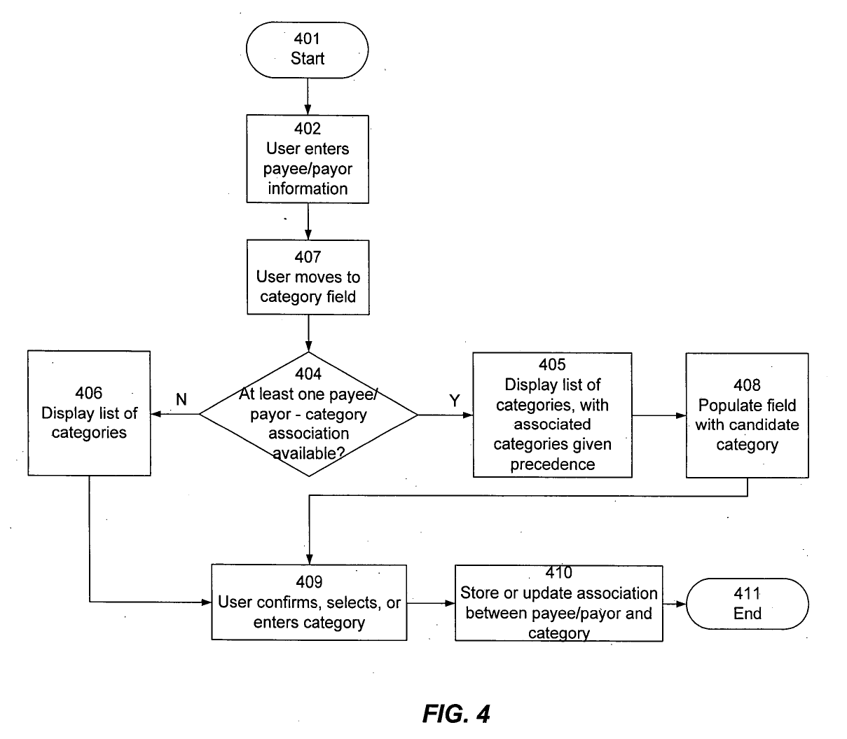

Referring now to FIG. 4, there is shown a flow diagram depicting a method for practicing the present invention according to one embodiment. In one embodiment, as described below, the present invention is implemented in a personal financial software application.

A user enters 402 or selects a payee/payor name for a transaction in a transaction register. In one embodiment, the system provides auto-fill and/or other functionality allowing the user to more easily enter the payee/payor name; such techniques are well known in the art.

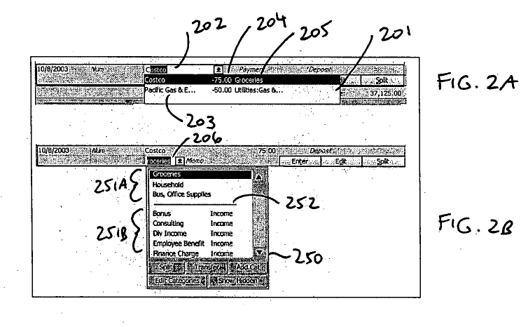

Referring now briefly to FIG. 2A, there is shown an example of an auto-fill function coupled with a pull-down menu 201 of payee/payor names. The user has entered the first character in payee/payor field 202 and is presented with pull-down menu 201 including payee/payor names 203 that match the entered text. Transaction amounts 204 and default categories 205 are shown in pull-down menu 201 so as to assist the user in selecting the most appropriate transaction. Fields in the transaction records are automatically populated based on the user's selection from pull-down menu 201. In one embodiment, the payee/payor names 203 and other information presented in pull-down menu 201 are based on transactions previously entered by the user (or previously downloaded from a source such as a financial institution).

In other embodiments, the user can simply enter the payee/payor name in field 202 by typing the information.

The user moves 407 to category field 206, either by hitting Tab (or some other key), or by moving an on-screen cursor to category field 206. The system determines 404 whether any payee/payor-category associations have previously been stored. In one embodiment, the system makes such a determination by checking data store 225, shown in FIG. 3, for records containing associations for the user-entered payee/payor. In another embodiment, the system infers one or more associations between payee/payor and category. Such inferences can be made based on any data already known, including for example an analysis of the name of the payee/payor (for example Red Robin Restaurants), and/or analysis of explicit associations made between similar payee/payors and particular categories, and/or any other factors.

If, in 404, it is determined that no associations have been stored (and none can be inferred), a pull-down menu 250 is displayed 406 containing a list of categories. In one embodiment, the pull-down menu 250 is sorted alphabetically. In another embodiment, it is sorted by category type (income or expense). The user can select a category from the pull-down menu 250 via arrow keys or by clicking on the desired category using an on-screen cursor. As shown in FIG. 2B, the pull-down menu 250 can be scrollable. Also, in one embodiment, the user can select a category by typing the first few characters of the category name; a matching category in the pull-down menu 250 is highlighted, and the category name is tentatively entered in category field 206. The user can accept the highlighted selection, for example by hitting an Enter or Tab key, or can choose another selection by navigating within the pull-down menu 250.

In another embodiment, categories that are of the same type as the present transactions are displayed more prominently than other categories, for example by being displayed near or at the top of the pull-down menu 250, and/or by being displayed in bold and/or in a distinctive color and/or some other visually distinguishable manner. Then, if two or more categories match the user-entered text, the best candidate among the matching categories can be highlighted as the most likely choice. Such techniques are described, for example, in related U.S. patent application Ser. No. ______ (Attorney Docket Number 9911), for INTELLIGENT AUTO-FILL OF TRANSACTION DATA, the disclosure of which is incorporated herein by reference.

In another embodiment, no pull-down menu is shown; rather, the user simply types text in category field 206. Auto-fill techniques may be used, so that category field 206 is tentatively populated with a category name matching characters entered by the user. Techniques described in the above-referenced patent application can be used for determining which category is likely to be the one intended by the user, particularly when two or more categories match the entered characters.

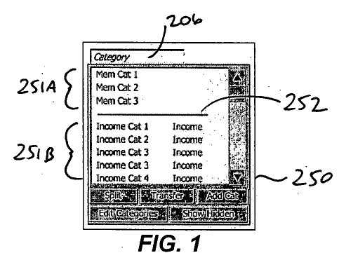

If, in 404, it is determined that at least one payee/payor-category association has previously been stored, a pull-down menu 250 is displayed 405 containing a list of categories, with the category or categories 251A associated with the user-entered payee/payor being given precedence over other categories 251B. For example, the associated category or categories 251A can be shown before other categories 251B. Referring now to FIG. 1, there is shown an example of such a pull-down menu 250. Referring also to FIG. 2B, there is shown an example of such a pull-down menu 250 in the context of a transaction entry. As shown in FIGS. 1 and 2B, a separator 252 can be included to further distinguish associated categories 251A from other categories 251B. Although in the Figures separator 252 is shown as a horizontal line, other types of separators 252 can be used, including for example an empty space between associated categories 251A and other categories 251B.

In one embodiment, pull-down menu 250 shows category or categories 251A associated with the user-entered payee/payor in a manner that is visually distinct from the display of other categories 251B; for example, associated categories 251A can be shown in bold-face, and/or in a different color than other categories 251B. In another embodiment, pull-down menu 250 only contains associated categories 251A; if the user wishes to enter another category, he or she can type the name of the desired category.

In one embodiment, if there are two or more associated categories 251A for the user-entered payee/payor, the associated categories 251A are listed in alphabetical order in pull-down menu 250, prior to the listing of other categories 251B. In another embodiment, the most recently used category 251A for the user-entered payee/payor is shown first, and any remaining associated categories 251A are listed in order of decreasing recency of use. In another embodiment, the most commonly used category 251A for the user-entered payee/payor is shown first, and any remaining associated categories 251A are listed in order of decreasing frequency of use. Determination of frequency of use can be limited to a particular period of time, if desired, such as for example the past year.

In one embodiment, the number of associated categories 251A shown in pull-down menu 250 is limited to some predetermined number, such as five. Thus, if more than that number of categories 251A is associated with the user-entered payee/payor, the most recently-used (or the most frequently-used) categories 251A are shown, up to the predetermined number limit.

In one embodiment, category field 206 is tentatively populated 408 with the topmost category in pull-down menu 250. The user can accept the entered category, for example by hitting a Tab or Enter key, or can override the category entry by typing or by selecting a different category from pull-down menu 250.

The user confirms, selects, or enters 409 the desired category using any appropriate input technique. For example, the user can confirm a highlighted or auto-filled category by hitting Tab or Enter, or can select a category by clicking on it or using arrow keys, or can enter a category using the keyboard.

If no association previously existed between the user-entered payee/payor and the user-selected category, an association is stored 410. In one embodiment, a record containing the association is stored in data store 225, using conventional data storage techniques. In one embodiment, a maximum number of associations is specified for each payee/payor (for example, five associations per payee/payor); once the maximum is reached, a least-recently (or least-frequently) used association is deleted or overwritten whenever a new association is to be stored. In another embodiment, no pre-specified maximum number exists.

In one embodiment, previously stored associations can be deleted, for example in response to a user's request.

In one embodiment, records containing associations between payees/payors and categories also contain additional information about the associations. For example, the records may indicate the most recent use of the association, the total number of times the association has been used, the initial date it was stored, and the like.

In one embodiment, if an association previously existed between the user-entered payee/payor and the user-selected category, the record containing the association is updated to reflect the most recent use of this association in the current transaction.

In one embodiment, the software application receives information regarding other users' payee/payor-category associations, based on usage of third party computers 215, and updates the local data store 225 accordingly. In this manner, other users' behavior patterns can be used to assist in selecting appropriate categories particular payees/payors. For example, if it is determined that other users tend to use a category of “Groceries” for the payee “Safeway”, an association between the Safeway payee and the Groceries category can be stored in data store 225, even if the local user has never indicated such an association. The local user's use or non-use of the category can subsequently cause the association to be deleted, updated, or otherwise modified.

In another embodiment, the software application can ship with a set of known default associations that are initially stored in data store 225 for use upon first launch of the product. The local user's use or non-use of the category can subsequently cause the association to be deleted, updated, or otherwise modified.

In one embodiment, the above-described techniques can be used for categorization of downloaded transactions. When a user downloads a transaction (or group of transactions), in one embodiment a default category is assigned to each transaction. The default category can be assigned based on previously stored associations between payees/payors and categories. The selection of default category can also take into account other information such as transaction type, as described in the related U.S. patent application referenced above. If more than one association exists for the payee/payor that appears in the downloaded transaction, the selection of which category to use as the default can be made based on recency of category use, frequency of category use, and/or other information such as transaction type, or any combination thereof.

If the user wishes to override the default category, he or she enters the category field and is presented with a user interface similar to that described herein. For example, as described herein, a pull-down menu 250 is presented in one embodiment, with associated categories being given prominence over other categories.

In another embodiment, no default category is assigned to a downloaded transaction, but the user is able to select a category using techniques described herein. For example, as described herein, a pull-down menu 250 is presented in one embodiment, with associated categories being given prominence over other categories.

Upon user selection of a category for a downloaded transaction, associations between payee/payor and category are stored and/or updated accordingly, as described herein.

As described above, in one embodiment, the last N categories used for the payee/payor are shown, followed by a list of other categories. N may be any number, such as for example five. The most recently used category for the payee/payor is shown first in the list, with other associated categories being shown in order of decreasing recency of use.

In one embodiment, associations between payees/payors and “splits” may also be stored. A split is a designation that a transaction should be split among two or more categories. Thus, for example, an association may be stored that indicates that Costco transactions are sometimes split among Groceries and Household. In one embodiment, splits appear within the category drop-down menu 250 according to their recency of use. In one embodiment, only one split (the most recently used one) appears; in another embodiment, there is no limit to the number of splits that can appear within the top portion of category drop-down menu 250 (other than the overall limit on associated categories being displayed therein). In yet another embodiment, any other numeric limit can be imposed on the number of split transactions shown within drop-down menu 250.

In one embodiment, if the user selects a category split, he or she is given the opportunity to adjust the split amounts for each category within the split, either as a percentage or absolute amount. A default may be shown, for example corresponding to the proportion of split amount applied to each category the last time that category split was applied to that payee/payor.

Some financial software applications provide a capability to memorize transactions. Memorized transactions can include payee/payor information and categorization information, as well as a transaction amount if desired. In one embodiment of the present invention, if a transaction for the user-entered payee/payor has been memorized, and if the memorized transaction includes category information, the category for the memorized transaction appears before other associated categories in the category drop-down menu 250. Also, the category for the memorized transaction is tentatively populated in the category field. This takes place even if the category associated with the memorized transaction was not used as recently (or as frequently) as other categories. In other words, categorization information for memorized transactions takes precedence over other categorization associations for the user-entered payee/payor.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is exemplary, and not mandatory; functions performed by a single system component may instead be performed by multiple components, and functions performed by multiple components may instead be performed by a single component.

In addition, although the above description sets forth the invention in terms of presenting and selecting a category for a financial transaction, one skilled in the art will recognize that the invention can be implemented in other contexts as well. For example, the invention can be used for presenting a menu (or other list) of candidate entries for a field associated with a record. Based on previously stored associations between previous entries for the field and data entered in other fields of the record, certain candidate entries can be given precedence over other candidate entries, according to the techniques described herein. In this manner, the invention can be implemented in connection with any data entry operation where a set of candidate entries for a field of a record is designated as being more likely to be appropriate for the record than are other candidate entries.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for displaying a menu of candidate entries for a record, the method comprising:
receiving an entry for a second field of the record;
identifying at least two candidate entries for a first field of the record as being associated with the received entry for the second field of the record;
displaying a menu of candidate entries for the first field, the menu comprising the associated candidate entries and at least one other candidate entry, wherein the associated candidate entries are displayed visually distinctively from the at least one other candidate entry;
receiving input indicating an entry for the first field; and
storing the record including the indicated entry for the first field.

2. The method of claim 1, wherein the record comprises a financial transaction record.

3. The method of claim 2, wherein the second field comprises a payee field, and wherein receiving the entry for a second field comprises receiving a payee name.

4. The method of claim 3, wherein the first field comprises a category field, and wherein:
identifying at least two candidate entries comprises identifying at least two categories as being associated with the received payee name;
displaying a menu of candidate entries for the first field comprises displaying a menu of categories, the menu comprising the associated categories and at least one category, wherein the associated categories are displayed separately from the at least one other candidate entry; and
receiving input indicating an entry comprises receiving input indicating a category for the financial transaction record.

5. The method of claim 2, wherein the second field comprises a payor field, and wherein receiving the entry for a second field comprises receiving a payor name.

6. The method of claim 5, wherein the first field comprises a category field, and wherein:
identifying at least two candidate entries comprises identifying at least two categories as being associated with the received payor name;
displaying a menu of candidate entries for the first field comprises displaying a menu of categories, the menu comprising the associated categories and at least one category, wherein the associated categories are displayed separately from the at least one other candidate entry; and
receiving input indicating an entry comprises receiving input indicating a category for the financial transaction record.

7. The method of claim 1, wherein receiving input indicating an entry for the first field comprises receiving user input selecting a candidate entry from the displayed menu.

8. The method of claim 1, wherein receiving input indicating an entry for the first field comprises receiving user input entered via a keyboard.

9. The method of claim 8, wherein the user input entered via a keyboard does not correspond to any candidate entry in the menu.

10. The method of claim 8, wherein the user input entered via a keyboard corresponds to at least a portion of a candidate entry in the menu.

11. The method of claim 8, wherein the user input entered via a keyboard corresponds to an initial portion of a candidate entry in the menu, the method further comprising populating the first field with the candidate entry having an initial portion corresponding to the user input.

12. The method of claim 1, wherein each of the identified candidate entries appears in a previously entered transaction having data corresponding to the received entry for the second field.

13. The method of claim 1, wherein receiving an entry for a second field of the record comprises receiving the entry from a user.

14. The method of claim 13, wherein receiving an entry for a second field of the record comprises receiving the entry from a first user at a first computer, and wherein at least one of the previously entered transactions having data corresponding to the received entry for the second field was entered by a user other than the first user.

15. The method of claim 13, wherein receiving an entry for a second field of the record comprises receiving the entry from a first user at a first computer, and wherein at least one of the previously entered transactions having data corresponding to the received entry for the second field was entered at a computer other than the first computer.

16. The method of claim 1, wherein receiving an entry for a second field of the record comprises receiving a downloaded transaction record having data for the second field.

17. The method of claim 1, wherein identifying at least two candidate entries for the first field as being associated with the received entry for the second field comprises retrieving a stored association record indicating the association.

18. The method of claim 17, further comprising, responsive to the received input indicating an entry for the first field, updating the stored association record indicating the association.

19. The method of claim 17, further comprising, responsive to the received input indicating an entry for the first field, storing a new association record indicating the association.

20. The method of claim 17, further comprising, responsive to the received input indicating an entry for the first field, and responsive to the number of previously stored association records corresponding to the first field entry equaling or exceeding a predetermined limit, deleting a previously stored association record and creating a new association record indicating the association.

21. The method of claim 20, wherein deleting a previously stored association record comprises deleting a least recently used association record.

22. The method of claim 20, wherein deleting a previously stored association record comprises deleting a least frequently used association record.

23. The method of claim 1, wherein identifying at least two candidate entries for the first field as being associated with the received entry for the second field comprises inferring at least one association.

24. The method of claim 1, wherein displaying the menu of candidate entries comprises:
responsive to the number of associated candidate entries exceeding a predetermined limit, displaying the menu of candidate entries for the first field, the menu comprising a subset of the associated candidate entries not exceeding the predetermined limit and at least one other candidate entry, wherein the displayed associated candidate entries are displayed separately from the at least one other candidate entry.

25. The method of claim 24, the subset of the associated candidate entries comprises the most recently used associated candidate entries.

26. The method of claim 24, the subset of the associated candidate entries comprises the most frequently used associated candidate entries.

27. The method of claim 1, wherein displaying a menu of candidate entries comprises displaying the associated candidate entries above the at least one other candidate entry.

28. The method of claim 1, wherein displaying a menu of candidate entries further comprises displaying a separator between the associated candidate entries and the at least one other candidate entry.

29. The method of claim 1, wherein displaying a menu of candidate entries comprises displaying the associated candidate entries in a different font than the at least one other candidate entry.

30. The method of claim 1, wherein displaying a menu of candidate entries comprises displaying the associated candidate entries in a bold-face font.

31. The method of claim 1, wherein displaying a menu of candidate entries comprises displaying the associated candidate entries in a different color than the at least one other candidate entry.

32. The method of claim 1, further comprising, prior to receiving input indicating an entry for the first field, displaying in the first field one of the associated candidate entries.

33. The method of claim 1, wherein associated candidate entries in the menu of candidate entries are sorted by decreasing recency of use.

34. The method of claim 1, wherein associated candidate entries in the menu of candidate entries are sorted by decreasing frequency of use.

35. A computer program product for displaying a menu of candidate entries for a record, the computer program product comprising:
a computer-readable medium; and
computer program code, encoded on the medium, for:
receiving an entry for a second field of the record;
identifying at least two candidate entries for a first field of the record as being associated with the received entry for the second field of the record;
displaying a menu of candidate entries for the first field, the menu comprising the associated candidate entries and at least one other candidate entry, wherein the associated candidate entries are displayed visually distinctively from the at least one other candidate entry;
receiving input indicating an entry for the first field; and
storing the record including the indicated entry for the first field.

36. The computer program product of claim 35, wherein the record comprises a financial transaction record.

37. The computer program product of claim 36, wherein the second field comprises a payee field, and wherein the computer program code for receiving the entry for a second field comprises computer program code for receiving a payee name.

38. The computer program product of claim 37, wherein the first field comprises a category field, and wherein:
the computer program code for identifying at least two candidate entries comprises computer program code for identifying at least two categories as being associated with the received payee name;
the computer program code for displaying a menu of candidate entries for the first field comprises computer program code for displaying a menu of categories, the menu comprising the associated categories and at least one category, wherein the associated categories are displayed separately from the at least one other candidate entry; and
the computer program code for receiving input indicating an entry comprises computer program code for receiving input indicating a category for the financial transaction record.

39. The computer program product of claim 35, wherein the second field comprises a payor field, and wherein receiving the entry for a second field comprises receiving a payor name.

40. A system for displaying a menu of candidate entries for a record, the system comprising:
an input device, for receiving an entry for a second field of the record;
a processor, for identifying at least two candidate entries for a first field of the record as being associated with the received entry for the second field of the record;
a display device, for displaying a menu of candidate entries for the first 8 field, the menu comprising the associated candidate entries and at least one other candidate entry, wherein the associated candidate entries are displayed visually distinctively from the at least one other candidate entry;
wherein the input device receives input indicating an entry for the first field; and
a storage device, for storing the record including the indicated entry for the first field.

41. The system of claim 40, wherein the record comprises a financial transaction record.

42. The system of claim 41, wherein the second field comprises a payee field, and wherein the input device receives a payee name.

43. The system of claim 42, wherein the first field comprises a category field, and wherein:
the processor identifies at least two candidate entries by identifying at least two categories as being associated with the received payee name;
the display device displays a menu of candidate entries for the first field by displaying a menu of categories, the menu comprising the associated categories and at least one category, wherein the associated categories are displayed separately from the at least one other candidate entry; and
the input device receives input indicating an entry by receiving input indicating a category for the financial transaction record.

44. The system of claim 41, wherein the second field comprises a payor field, and wherein the input device receives a payor name.
